(19) United States
(12) Patent Application Publication
(10) Pub. No.: US 2026/0133595 A1
(43) Pub. Date: May 14, 2026

(54) GAS SUPPLY SYSTEM

(71) Applicant: TOYOTA JIDOSHA KABUSHIKI KAISHA, Toyota-shi (JP)

(72) Inventors: Yoshikatsu Fujimura, Toyota-shi (JP); Naoki Tomi, Kawasaki-shi (JP); Tetsuya Tonosako, Fuji-shi (JP)

(73) Assignee: TOYOTA JIDOSHA KABUSHIKI KAISHA, Toyota-shi (JP)

(21) Appl. No.: 19/371,283

(22) Filed: Oct. 28, 2025

(30) Foreign Application Priority Data
Nov. 12, 2024 (JP) 2024-197401

(51) Int. Cl. G05D 7/06; H01M 8/04082; H01M 8/0438; H01M 8/04746

(52) U.S. Cl. CPC G05D 7/0635; H01M 8/04201; H01M 8/04388; H01M 8/04753

(57) ABSTRACT

A system includes a tank provided with an automatic valve, a pipe connecting the tank and a device, a sealing, and a shutoff valve disposed in the pipe. A rod is provided at the tip of the pipe, and pushes open the automatic valve when the tank approaches. The sealing seals a space including the automatic valve and the tip of the pipe when the distance between the automatic valve and the rod is equal to or less than a threshold. A controller moves the tank forward until the automatic valve is pushed open, and then moves the tank backward to a position at which the automatic valve is closed while holding the space sealed, and closes the shutoff valve. The controller determines that a gas leak is occurring when the pressure in the pipe upstream of the shutoff valve is less than the pressure downstream of the shutoff valve.

### CROSS-REFERENCE TO RELATED APPLICATION

This application claims priority to Japanese Patent Application No. 2024-197401 filed on November 12, 2024. The disclosure of the above-identified application, including the specification, drawings, and claims, is incorporated by reference herein in its entirety.

### BACKGROUND

### 1. Technical Field

The technology disclosed herein relates to a gas supply system that supplies a gas in a gas tank to a gas consuming device.

### 2. Description of Related Art

Japanese Unexamined Patent Application Publication No. 2024-89965 (JP 2024-89965 A) discloses a gas supply system that includes a plurality of gas tanks and supplies a gas from the gas tanks to a gas consuming device. The gas supply system according to JP 2024-89965 A performs a gas leak check prior to replacing the gas tanks when the remaining amount of the gas in all the gas tanks becomes small. When the remaining amount of all the gas tanks becomes small, a controller of the system closes open/close valves of all the gas tanks, and shuts down the gas consuming device after consuming the gas in the gas supply pipe. After that, the controller disconnects the gas tanks from the system after confirming that the gas pressure in the gas supply pipe is not increased. When the gas pressure in the gas supply pipe is increased, it is indicated that the gas is leaking from the open/close valves. In this case, when the gas tanks are disconnected from the system, the gas in the gas tanks leaks to the surrounding area. When the gas pressure in the gas supply pipe is increased, the controller stops disconnection of the gas tanks.

### SUMMARY

In the gas supply system according to JP 2024-89965 A, the presence or absence of a gas leak is detected based on whether the gas pressure in the gas supply pipe is increased. Therefore, it is necessary to temporarily stop the gas supply to the gas consuming device in order for a gas leak check. The present specification provides a technique that allows a gas leak check to be performed without stopping the gas supply to a gas consuming device.

An aspect of the present specification discloses a gas supply system including a gas tank, a gas supply pipe, an actuator, a sealing, a shutoff valve, first and second pressure sensors, and a controller. The gas tank includes an automatic closing valve that opens when a push rod is pushed in and closes when the push rod is pulled out. The gas tank is connected to the gas supply pipe. The push rod is provided at a tip of the gas supply pipe, and the gas supply pipe leads a gas from the gas tank to a gas consuming device. The actuator moves the gas tank forward and backward relative to the gas supply pipe. The sealing seals a connection space including an opening of the automatic closing valve and the tip of the gas supply pipe when a distance between the automatic closing valve and the push rod is shorter than a predetermined threshold distance. The shutoff valve is provided in the gas supply pipe. The first pressure sensor measures a pressure in the gas supply pipe upstream of the shutoff valve. The second pressure sensor measures a pressure in the gas supply pipe downstream of the shutoff valve.

The controller is configured to control the actuator so as to move the gas tank forward until the automatic closing valve is pushed open, and then move the gas tank backward to a position at which the automatic closing valve is closed while holding the connection space sealed and close the shutoff valve. Furthermore, the controller is configured to, after a predetermined time, move the gas tank forward such that the automatic closing valve opens again and open the shutoff valve when a measurement value of the first pressure sensor is equal to or more than a measurement value of the second pressure sensor, and output a signal indicating that a gas leak is occurring when the measurement value of the first pressure sensor is less than the measurement value of the second pressure sensor.

When the automatic closing valve of the gas tank is opened, the supply of a gas to the gas consuming device is started. In the gas supply system disclosed herein, a gas leak check is performed upstream of the shutoff valve in a state in which the gas supply pipe downstream of the shutoff valve is filled with a gas. The gas tank is moved backward to close the automatic closing valve, and the controller closes the shutoff valve while a gas leak check is being performed. A high-pressure gas accumulated in the gas supply pipe downstream of the shutoff valve continues to be supplied to the gas consuming device. The gas supply system disclosed herein can perform a gas leak check without stopping the gas supply to the gas consuming device.

In the gas supply system disclosed herein, the gas supply pipe may be divided into a plurality of branch paths, and each of the branch paths may be provided with the first pressure sensor and the push rod. The gas tank may be connected to each of the branch paths. The actuator is preferably able to move the gas tank relative to the push rod in each of the branch paths. One gas tank can be replaced while a gas is supplied from the other gas tank to the gas consuming device.

Details of the technology disclosed herein and further improvements will be described in the "DETAILED DESCRIPTION OF EMBODIMENTS" below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a gas supply system according to a first embodiment;

FIG. 2 is a cross-sectional view of a gas tank and a gas supply pipe (sealing position);

FIG. 3 is a cross-sectional view of the gas tank and the gas supply pipe (open valve position);

FIG. 4 is a flowchart of a gas leak check process;

FIG. 5 is a block diagram of a gas supply system according to a second embodiment; and

FIG. 6 is a flowchart of a gas leak check process (second embodiment).

### DETAILED DESCRIPTION OF EMBODIMENTS

### First Embodiment

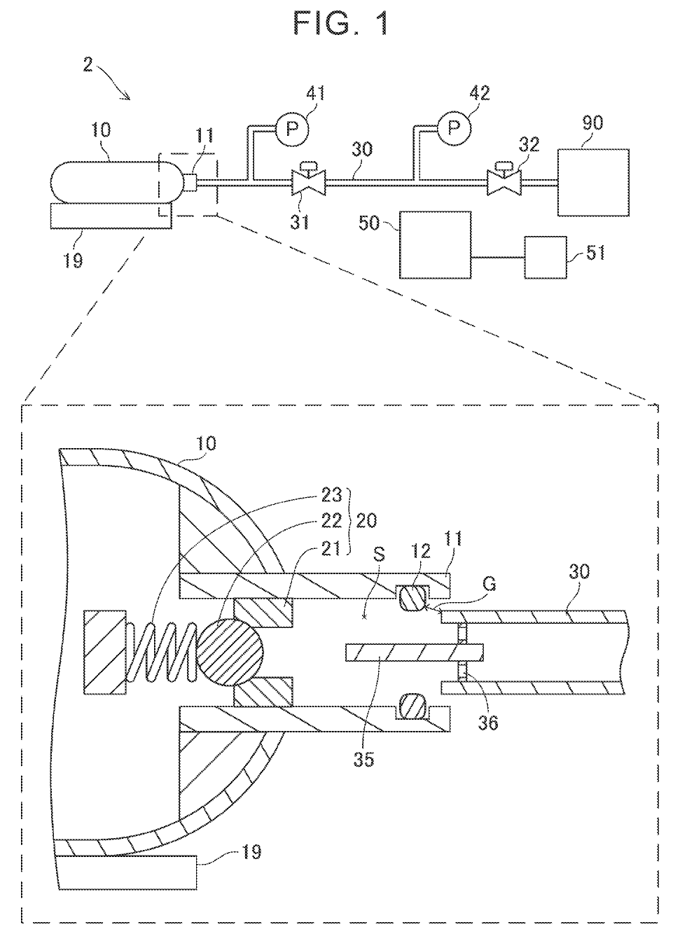

A gas supply system 2 according to a first embodiment will be described with reference to FIGS. 1 to 4. FIG. 1 is a block diagram of the gas supply system 2. A fuel cell 90 is connected to the gas supply system 2 according to the embodiment, and the gas supply system 2 supplies a hydrogen gas from a gas tank 10 to the fuel cell 90. The fuel cell 90 is an example of a gas consuming device to which the gas supply system 2 supplies a gas.

The gas supply system 2 includes a gas tank 10, a gas supply pipe 30, a push rod 35, an actuator 19, a first pressure sensor 41, a second pressure sensor 42, a shutoff valve 31, a controller 50, and a display device 51.

In the present embodiment, the gas tank 10 is filled with a high-pressure hydrogen gas. The gas tank 10 and the fuel cell 90 are connected by the gas supply pipe 30. The gas supply pipe 30 leads the hydrogen gas in the gas tank 10 to the fuel cell 90. The shutoff valve 31 and a pressure reducing valve 32 are connected to the gas supply pipe 30. The pressure reducing valve 32 is disposed downstream of the shutoff valve 31. Here, the term "downstream" refers to the side of the gas supply pipe 30 that is closer to the fuel cell 90 (gas consuming device), and the term "upstream" refers to the side that is closer to the gas tank 10.

The pressure reducing valve 32 reduces the pressure of the hydrogen gas supplied from the gas tank 10 to a pressure suitable for operation of the fuel cell 90. That is, the gas pressure suitable for operation of the fuel cell 90 is lower than the pressure of the gas supplied from the gas tank 10.

The shutoff valve 31 opens and closes according to a command from the controller 50. More specifically, the shutoff valve 31 is open during operation of the fuel cell 90, and is closed according to a command from the controller 50. For example, when a gas leak occurs at the connection point between the gas tank 10 and the gas supply pipe 30, the controller 50 closes the shutoff valve 31 to suppress a hydrogen gas leaking to the outside from downstream of the shutoff valve 31. Furthermore, the controller 50 temporarily closes the shutoff valve 31 in a gas leak check process, which will be described later.

The first pressure sensor 41 measures the pressure in the gas supply pipe 30 upstream of the shutoff valve 31. When the gas tank 10 is connected to the gas supply pipe 30, the measurement value of the first pressure sensor 41 is substantially equal to the internal pressure of the gas tank 10 (the measurement value is lower than the internal pressure of the tank by an amount corresponding to a pressure loss due to an automatic closing valve 20 described below, etc.).

The second pressure sensor 42 measures the pressure in the gas supply pipe 30 downstream of the shutoff valve 31. While a gas is supplied from the gas tank 10, the measurement value of the second pressure sensor 42 is substantially equal to the measurement value of the first pressure sensor 41 (the measurement value of the second pressure sensor 42 is lower than the measurement value of the first pressure sensor 41 by an amount corresponding to a pressure loss due to the shutoff valve 31, etc.).

A cross-sectional view of a fitting 11 of the gas tank 10 and the tip of the gas supply pipe 30 is illustrated on the lower side of FIG. 1. The fitting 11 of the gas tank 10 includes an automatic closing valve 20. The automatic closing valve 20 includes a sleeve 21, a valve body 22, and a spring 23. The sleeve 21 is attached inside the fitting 11. The valve body 22 is disposed adjacent to the sleeve 21 within the tank. The spring 23 presses the valve body 22 against the opening of the sleeve 21 (the opening that opens into the tank) from inside the tank. The opposite end of the spring 23 is supported by an inner wall of the tank.

The force of the spring 23 causes the valve body 22 to be in close contact with the opening of the sleeve 21. The automatic closing valve 20 is closed while the valve body 22 is in close contact with the opening of the sleeve 21. The automatic closing valve 20 opens when the valve body 22 is pushed inward from the outside of the tank. When the load on the valve body 22 is removed, the force of the spring 23 causes the valve body 22 to come back into close contact with the opening of the sleeve 21, closing the automatic closing valve 20.

The push rod 35 is provided at the tip of the gas supply pipe 30. The push rod 35 is fixed to the tip of the gas supply pipe 30 by a rod support 36. The rod support 36 has a hole, through which a gas can flow from the gas tank 10 into the gas supply pipe 30.

When the gas tank 10 is set in the gas supply system 2, the push rod 35 at the tip of the gas supply pipe 30 faces the fitting 11. The actuator 19 moves the gas tank 10. The actuator 19 moves the gas tank 10 closer to and away from the gas supply pipe 30. More specifically, the actuator 19 moves the automatic closing valve 20 closer to and away from the tip of the gas supply pipe 30 (i.e., the push rod 35). The cross-sectional view in FIG. 1 illustrates a state in which the push rod 35 is away from the automatic closing valve 20.

The actuator 19 moves the gas tank 10 forward and backward relative to the tip of the gas supply pipe 30. When the gas tank 10 moves closer to the gas supply pipe 30, it is referred to as "moving forward", and when the gas tank 10 moves away from the gas supply pipe 30, it is referred to as "moving backward". The actuator may move the gas supply pipe 30 forward and backward relative to the gas tank 10.

A sealing 12 is disposed inside the fitting 11. When the tip (push rod 35) of the gas supply pipe 30 moves closer to the automatic closing valve 20, the outer periphery of the gas supply pipe 30 comes into contact with the sealing 12, and a space including the opening of the automatic closing valve 20 (the opening that opens to the outside of the gas tank 10) and the tip of the gas supply pipe 30 is sealed. For convenience, the space including the opening of the automatic closing valve 20 and the tip of the gas supply pipe 30 is referred to as a connection space S. More precisely, the connection space S refers to a space inside the fitting 11 including the opening of the automatic closing valve 20 and the tip of the gas supply pipe 30. In the cross-sectional view in FIG. 1, the push rod 35 is away from the automatic closing valve 20, and a gap G is maintained between the tip of the gas supply pipe 30 and the sealing 12. In this state, the connection space S is not sealed off from the external environment.

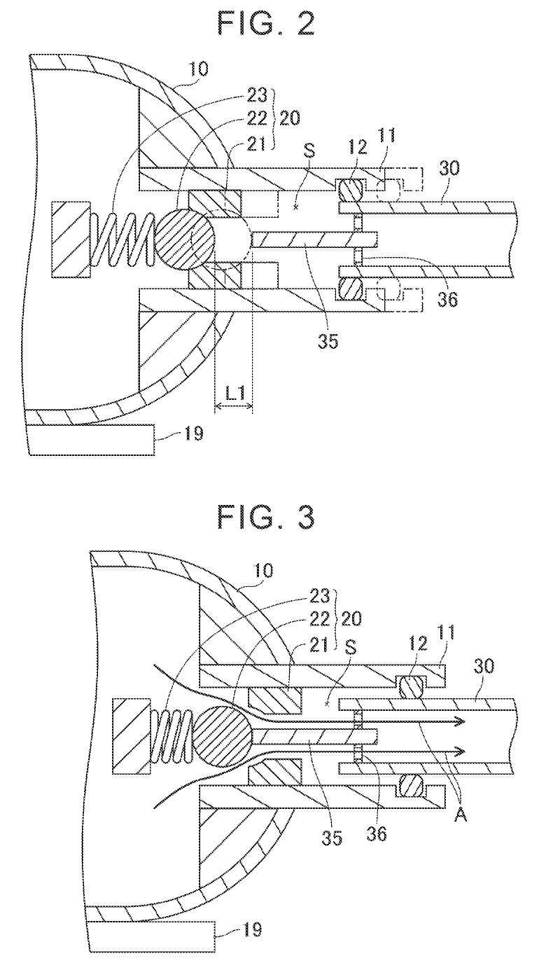

FIG. 2 illustrates a cross section at the time when the tip of the gas supply pipe 30 is in contact with the sealing 12. When the distance between the push rod 35 and the automatic closing valve 20 reaches L1, the sealing 12 comes into contact with the outer periphery of the gas supply pipe 30, and the connection space S is sealed. In other words, when the distance between the push rod 35 and the valve body 22 of the automatic closing valve 20 becomes shorter than L1, the connection space S is shut off from the external environment. When the distance between the push rod 35 and the valve body 22 is L1, the automatic closing valve 20 remains closed. The distance L1 may be referred to as a threshold distance.

The hidden outlines in FIG. 2 indicate a state in which the gas tank 10 has moved forward until the valve body 22 comes into contact with the tip of the push rod 35. When the gas tank 10 moves further forward than the hidden outlines, the push rod 35 pushes the automatic closing valve 20 open. FIG. 3 is a cross-sectional view at the time when the gas tank 10 has moved forward until the automatic closing valve 20 is opened. The thick arrows A indicate the flow of the gas. While the automatic closing valve 20 is open, the hydrogen gas in the gas tank 10 flows through the connection space S to the gas supply pipe 30. Since the connection space S is sealed by the sealing 12, the hydrogen gas does not leak to the outside.

The gas in the gas tank 10 passes through the open automatic closing valve 20, passes through the hole in the rod support 36 , and flows to the gas supply pipe 30. For the convenience of description, the position of the gas tank 10 at the time when the connection space S is sealed but the automatic closing valve 20 is closed is referred to as a sealing position, and the position of the gas tank 10 at the time when the connection space S is sealed and the automatic closing valve 20 is open is referred to as an open valve position. FIG. 2 is a cross-sectional view in the sealing position, and FIG. 3 is a cross-sectional view in the open valve position. In the sealing position, the distance between the push rod 35 and the valve body 22 of the automatic closing valve 20 is equal to or less than L1 and greater than zero. Also in the open valve position, the sealing 12 is in contact with the outer periphery of the gas supply pipe 30, and the connection space S remains sealed.

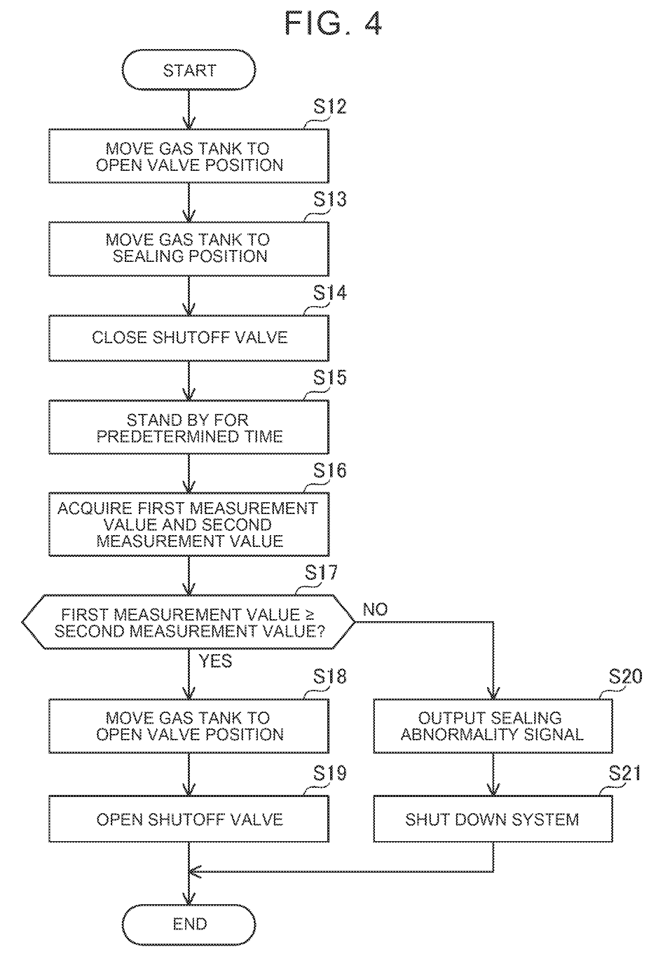

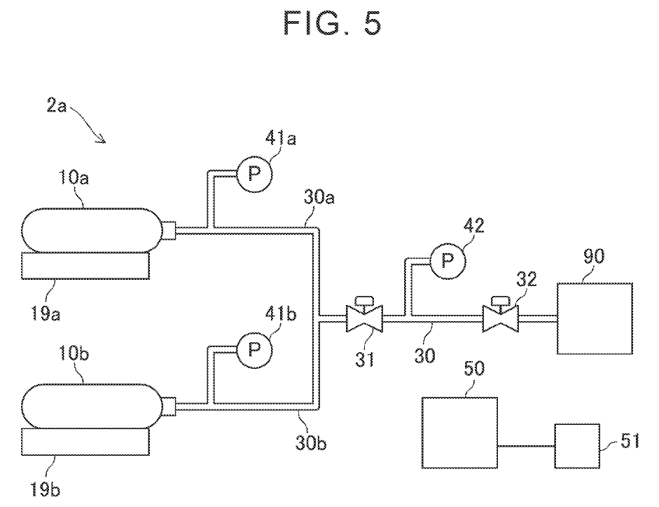

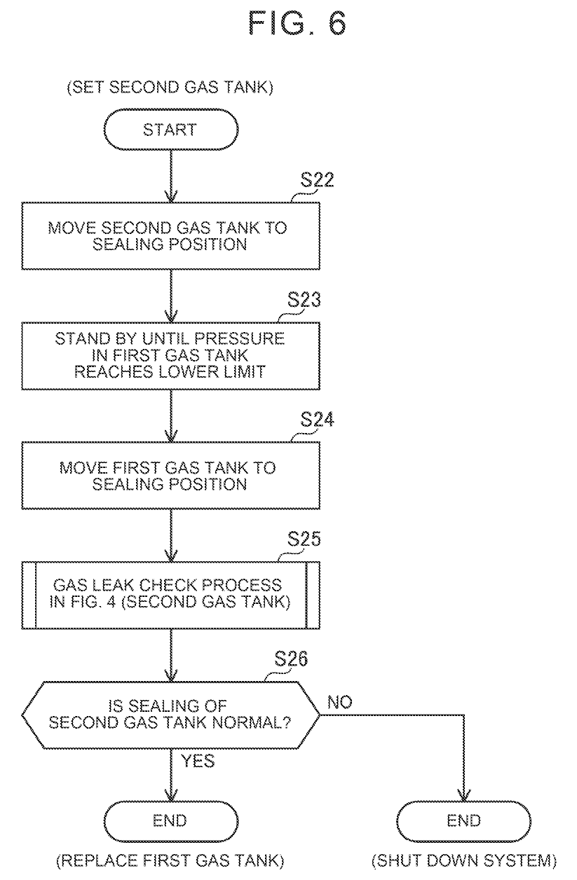

The controller 50 (see FIG. 1) controls the actuator 19, and checks a gas leak at the sealing 12. FIG. 4 is a flowchart of a gas leak check process. The controller 50 starts the gas leak check process when the gas tank 10 is set in the gas supply system 2 (actuator 19).

Next, the gas leak check process will be described with reference to the flowchart in FIG. 4. The gas leak check process starts when the gas tank 10 is set in the gas supply system 2. The controller 50 moves the gas tank 10 to the valve open position (step S12). The automatic closing valve 20 opens, and the hydrogen gas in the gas tank 10 flows to the gas supply pipe 30. The hydrogen gas is supplied to the fuel cell 90 through the gas supply pipe 30. Since the hydrogen gas is supplied, the fuel cell 90 becomes operable. The fuel cell 90 may start operation.

Subsequently, the controller 50 moves the gas tank 10 to the sealing position (step S13), and closes the shutoff valve 31 (step S14). Next, the controller 50 stands by for a predetermined time (step S15). When the gas tank 10 moves to the sealing position, the automatic closing valve 20 is closed. However, since the area downstream of the shutoff valve 31 is filled with a high-pressure hydrogen gas, the hydrogen gas continues to be supplied to the fuel cell 90 for a while. That is, the fuel cell 90 can continue to operate.

After standing by for a predetermined time, the controller 50 acquires measurement values of the first pressure sensor 41 and the second pressure sensor 42, and compares the measurement values (steps S16 and S17). In FIG. 4, the measurement value of the first pressure sensor 41 is indicated as a "first measurement value", and the measurement value of the second pressure sensor 42 is indicated as a "second measurement value".

In step S16, the first measurement value (the measurement value of the first pressure sensor 41) indicates the pressure in the connection space S. The second measurement value (the measurement value of the second pressure sensor 42) indicates the pressure in the gas supply pipe 30 downstream of the shutoff valve 31. When no gas is leaking from the connection space S, the first measurement value is maintained. When a gas is leaking from the connection space S, the first measurement value continues to decrease for a predetermined time.

When the first measurement value is equal to or greater than the second measurement value, the controller 50 moves the gas tank 10 to the open valve position again (step S17: YES, S18). Furthermore, the controller 50 opens the shutoff valve 31 (step S19). When the first measurement value is equal to or greater than the second measurement value even after the predetermined time has elapsed, it can be determined that no gas is leaking from the connection space S sealed by the sealing 12. In that case, the controller 50 moves the gas tank 10 to the open valve position to open the automatic closing valve 20 and also opens the shutoff valve 31, continuing the supply of the gas from the gas tank 10 to the fuel cell 90.

When the first measurement value is less than the second measurement value, the controller 50 outputs a sealing abnormality signal to the display device 51, and shuts down the gas supply system 2 and the fuel cell 90 (steps S17: NO, S20, S21). The sealing abnormality signal is a signal indicating that a gas leak is occurring at the sealing 12. When the sealing abnormality signal is received, the display device 51 turns on a warning lamp indicating that a gas leak is occurring at the sealing 12 (or the display device 51 produces a warning sound).

When the first measurement value is less than the second measurement value after the predetermined time has elapsed, it can be determined that the gas in the connection space S is leaking to the outside through the sealing 12. That is, it can be determined that a sealing abnormality is occurring. In that case, the controller 50 outputs a sealing abnormality signal indicating that a gas leak is occurring at the sealing 12. At this time, the controller 50 holds the gas tank 10 in the sealing position. Since the automatic closing valve 20 is closed in the sealing position, the gas in the connection space S does not leak to the outside. Furthermore, since the shutoff valve 31 of the gas supply pipe 30 is closed, the gas charged in the gas supply pipe 30 downstream of the shutoff valve 31 does not leak to the connection space S.

In the manner described above, the gas supply system 2 can check a gas leak at the sealing 12 without stopping the gas supply to the fuel cell 90 (gas consuming device).

The actuator 19 will be described in more detail. In the gas supply system 2 according to the embodiment, the actuator 19 moves the gas tank 10 (automatic closing valve 20) closer to and away from the gas supply pipe 30 (push rod 35). The actuator may move the gas supply pipe 30 (push rod 35) closer to and away from the automatic closing valve 20. In other words, the actuator may be any device that moves the gas tank 10 forward and backward relative to the gas supply pipe 30.

In the gas supply system 2 according to the embodiment, after the gas tank 10 is set, the controller 50 performs the following process as the gas leak check process. The shutoff valve 31 is opened before the gas leak check. (1) The controller 50 controls the actuator 19 so as to move the gas tank 10 forward until the automatic closing valve 20 is pushed open, and then moves the gas tank 10 backward to a position at which the automatic closing valve 20 is closed while holding the connection space S sealed and closes the shutoff valve 31. In other words, the controller 50 controls the actuator 19 so as to relatively move the gas tank 10 closer to the gas supply pipe 30 until the automatic closing valve 20 is pushed open, and then relatively moves the gas tank 10 away from the gas supply pipe 30 to a position at which the automatic closing valve 20 is closed while holding the connection space S sealed. At the same time, the controller 50 closes the shutoff valve 31.

(2) After a predetermined time, when the measurement value of the first pressure sensor 41 is equal to or greater than the measurement value of the second pressure sensor 42, the controller 50 moves the gas tank 10 forward such that the automatic closing valve 20 opens again, and opens the shutoff valve 31. In other words, after a predetermined time, when the measurement value of the first pressure sensor 41 is equal to or greater than the measurement value of the second pressure sensor 42, the controller 50 relatively moves the gas tank 10 toward the gas supply pipe such that the automatic closing valve 20 opens again. At the same time, the controller 50 opens the shutoff valve 31. On the other hand, when the measurement value of the first pressure sensor 41 is less than the measurement value of the second pressure sensor 42, the controller 50 outputs a sealing abnormality signal indicating that a gas leak is occurring.

In the embodiment, the sealing abnormality signal is sent to the display device 51. When the sealing abnormality signal is received, the display device 51 outputs a notification (message, warning light, warning sound, etc.) indicating that a gas leak is occurring at the sealing 12.

### Second Embodiment

A gas supply system 2a according to a second embodiment will be described with reference to FIGS. 5 and 6. FIG. 5 is a block diagram of the gas supply system 2a. The gas supply system 2a includes two gas tanks 10a and 10b. Each of the two gas tanks 10a and 10b has the same structure as the gas tank 10 of the gas supply system 2 according to the first embodiment, and has the structure illustrated in FIGS. 2 to 4. Each of the two gas tanks 10a and 10b includes a fitting 11 including a sealing 12 and an automatic closing valve 20.

A gas supply pipe 30 of the gas supply system 2a branches into a plurality of branch paths 30a and 30b at the middle. The branch path 30a is provided with a first pressure sensor 41a, and the branch path 30b is provided with a first pressure sensor 41b. The branch paths 30a and 30b are each a part of the gas supply pipe 30. A shutoff valve 31 is located downstream of the branch point of the gas supply pipe 30. The first pressure sensor 41a (41b) is provided upstream of the shutoff valve 31, and measures the pressure in the branch path 30a, 30b.

The gas tank 10a (10b) is set on an actuator 19a (19b). The actuators 19a and 19b are also the same as the actuator 19 according to the first embodiment.

The gas tank 10a is connected to the branch path 30a of the gas supply pipe 30, and the gas tank 10b is connected to the branch path 30b. In the gas supply system 2a, a hydrogen gas is supplied to the fuel cell 90 alternately from the two gas tanks 10a and 10b through the gas supply pipe 30. That is, when the remaining amount of the gas in the one gas tank 10a falls below a predetermined lower limit of the remaining amount, the gas supply system 2a stops the gas supply from the gas tank 10a and supplies a gas from the other gas tank 10b to the fuel cell 90. The gas tank 10a can be replaced with a new gas tank while a hydrogen gas is being supplied from the gas tank 10b to the fuel cell 90. When the remaining amount of the gas in the gas tank 10b falls below a predetermined lower limit of the remaining amount, the gas supply from the gas tank 10b is stopped, and a gas is supplied from the other gas tank 10a to the fuel cell 90. The gas tank 10b can be replaced with a new gas tank while a hydrogen gas is being supplied from the gas tank 10a to the fuel cell 90.

The gas supply system 2a performs a gas leak check prior to replacing the gas tank. FIG. 6 is a flowchart of a gas leak check process executed by a controller of the gas supply system 2a.

The gas leak check in the gas supply system 2a according to the second embodiment will be described with reference to the flowchart in FIG. 6. In the example in FIG. 6, the gas tank 10a is referred to as a first gas tank, and the gas tank 10b is referred to as a second gas tank. In the example in FIG. 6, the second gas tank 10b is replaced while a hydrogen gas is being supplied from the first gas tank 10a to the fuel cell 90. The gas leak check process in FIG. 6 is started when a new second gas tank 10b is set on the actuator 19b.

The controller 50 moves the second gas tank 10b to the sealing position (step S22). In the sealing position, the connection space S of the second gas tank 10b is sealed, and the automatic closing valve 20 remains closed.

The controller 50 stands by until the pressure in the first gas tank 10a reaches a predetermined lower limit (step S23). The measurement value of the first pressure sensor 41a provided in the branch path 30a is equal to the pressure in the first gas tank 10a. There is a positive correlation between the remaining amount and the pressure of a gas tank, and the remaining amount of the gas tank reaches a lower limit of the remaining amount when the pressure of the gas tank reaches a lower limit. That is, the process in step S23 is equivalent to "standing by until the remaining amount of the first gas tank 10a reaches the lower limit of the remaining amount".

When the pressure in the first gas tank 10a reaches the lower limit, the controller 50 moves the first gas tank 10a to the sealing position (step S24). The automatic closing valve of the first gas tank 10a is closed. Subsequently, the controller 50 performs the gas leak check process in FIG. 4 on the second gas tank 10b (step S25).

When the gas leak check process in FIG. 4 is executed for the second gas tank 10b, it is found whether a gas leak is occurring at the sealing 12 of the second gas tank 10b. When the sealing of the second gas tank 10b is normal, the controller 50 moves the second gas tank 10b to the open valve position and opens the shutoff valve 31 (steps S17: YES, S18, S19 in FIG. 4). The automatic closing valve of the second gas tank 10b opens, the shutoff valve 31 also opens, and a hydrogen gas is supplied from the second gas tank 10b to the fuel cell 90. When the supply of a hydrogen gas from the second gas tank 10b to the fuel cell 90 is started, a user replaces the first gas tank 10a. When a new first gas tank 10a is set, the gas leak check process in FIG. 6 is started for the new first gas tank 10a.

When the sealing of the second gas tank 10b is not normal, the controller 50 outputs a sealing abnormality signal indicating that an abnormality is occurring in the sealing 12 of the second gas tank 10b (step S17: NO, S20 in FIG. 4). When the sealing abnormality signal is received, the display device 51 outputs a message indicating that a gas leak is occurring at the sealing 12 of the second gas tank 10b (the display device 51 turns on a warning lamp or produces a warning sound). Then, the controller 50 shuts down the system (step S21 in FIG. 4).

While the gas leak check for the second gas tank 10b is being performed, the hydrogen gas charged in the gas supply pipe 30 downstream of the shutoff valve 31 continues to be supplied to the fuel cell 90. That is, the supply of a hydrogen gas to the fuel cell 90 continues even while the gas leak check process is being executed. There is no need to shut down the fuel cell 90 while the gas leak check process is being executed.

By providing a plurality of gas tanks, the gas supply system 2a allows one gas tank to be replaced while supplying a hydrogen gas from the other gas tank to the fuel cell 90.

The points to be noted regarding the technology described in the embodiment will be described. In the second embodiment, the gas supply system 2a includes two gas tanks. The gas supply system disclosed herein may include three or more gas tanks. When the occurrence of a gas leak at the sealing 12 is detected, the controller 50 outputs a sealing abnormality signal indicating that a gas leak is occurring. The sealing abnormality signal may be output to a host computer that manages the gas supply system, or to a terminal of a staff member that manages the gas supply system.

The gas supply system 2 (2a) according to the embodiment supplies hydrogen gas to the fuel cell 90. The fuel cell 90 is an example of a gas consuming device. The gas consuming device to which the gas supply system 2 (2a) supplies a gas may be a device other than the fuel cell 90. The gas pressure suitable for operation of the gas consuming device is lower than the internal pressure of the gas tank 10. Therefore, while the gas leak check process is being executed, the gas consuming device can continue to operate with the gas accumulated in the gas supply pipe 30 downstream of the shutoff valve 31.

The controller executes the following gas leak check process. (1) The controller 50 controls the actuator 19 so as to move the gas tank 10 forward until the automatic closing valve 20 is pushed open, and then moves the gas tank 10 backward to a position at which the automatic closing valve 20 is closed while holding the connection space S sealed and closes the shutoff valve 31.(2) After a predetermined time, when the measurement value of the first pressure sensor 41 is equal to or greater than the measurement value of the second pressure sensor 42, the controller 50 moves the gas tank 10 forward such that the automatic closing valve 20 opens again, and opens the shutoff valve 31. On the other hand, when the measurement value of the first pressure sensor 41 is less than the measurement value of the second pressure sensor 42, the controller 50 outputs a sealing abnormality signal indicating that a gas leak is occurring. The shutoff valve 31 is opened prior to the gas leak check process.

In the gas supply system 2a according to the second embodiment, the shutoff valve 31 is disposed downstream of the branch point of the gas supply pipe. The shutoff valve may be disposed in each of the branch paths 30a and 30b. A check valve may be provided upstream or downstream of the shutoff valve 31. The check valve allows a gas to flow from upstream to downstream and suppress a gas flowing from downstream to upstream. As stated above, the term "downstream" refers to the side of the gas supply pipe 30 that is closer to the fuel cell 90 (gas consuming device), and the term "upstream" refers to the side that is closer to the gas tank 10.

While it is possible to perform a gas leak check even when a check valve is provided instead of the shutoff valve 31, a reverse flow of a gas from the downstream side (gas consuming device side) to the upstream side (gas tank side) can be reliably suppressed by providing the shutoff valve 31.

While specific embodiments of the present disclosure have been described in detail above, the embodiments are merely exemplary and do not limit the scope of the claims. The technology described in the claims includes various modifications and variations of the specific embodiments described above. The technical elements described herein or illustrated in the drawings exhibit technical utility solely or in various combinations, and are not limited to the combination set forth in the claims as filed. In addition, the technology described herein or illustrated in the drawings can achieve a plurality of purposes at the same time, and provides technical utility by achieving one of the purposes alone.

What is claimed is:

1. A gas supply system comprising:
a gas tank including an automatic closing valve that opens when a push rod is pushed in and closes when the push rod is pulled out;
a gas supply pipe to which the gas tank is connected, at a tip of which the push rod is provided, and which leads a gas from the gas tank to a gas consuming device;
an actuator that moves the gas tank forward and backward relative to the gas supply pipe;
a sealing that seals a connection space including an opening of the automatic closing valve and the tip of the gas supply pipe when a distance between the automatic closing valve and the push rod is shorter than a predetermined threshold distance;
a shutoff valve provided in the gas supply pipe;
a first pressure sensor that measures a pressure in the gas supply pipe upstream of the shutoff valve;
a second pressure sensor that measures a pressure in the gas supply pipe downstream of the shutoff valve; and
a controller, wherein
the controller is configured to
control the actuator so as to move the gas tank forward until the automatic closing valve is pushed open, and then move the gas tank backward to a position at which the automatic closing valve is closed while holding the connection space sealed and close the shutoff valve, and
after a predetermined time, move the gas tank forward such that the automatic closing valve opens again and open the shutoff valve when a measurement value of the first pressure sensor is equal to or more than a measurement value of the second pressure sensor, and output a signal indicating that a gas leak is occurring when the measurement value of the first pressure sensor is less than the measurement value of the second pressure sensor.

2. The gas supply system according to claim 1, wherein:
the gas supply pipe is divided into a plurality of branch paths;
each of the branch paths is provided with the first pressure sensor and the push rod; and
the gas tank is connected to each of the branch paths.
